(19) United States
(12) Patent Application Publication
(10) Pub. No.: US 2024/0229883 A1
(43) Pub. Date: Jul. 11, 2024

(54) DISC BRAKE COMPRISING AN ADJUSTING UNIT

(71) Applicant: ZF CV Systems Europe BV, Brussels (BE)

(72) Inventor: Roman-Marius Mittendorf, Heppenheim (DE)

(21) Appl. No.: 18/559,930

(22) PCT Filed: May 5, 2022
(86) PCT No.: PCT/EP2022/062092

§ 371 Date: Nov. 9, 2023

(30) Foreign Application Priority Data
May 12, 2021 (DE) 10 2021 112 398.4

(51) Int. Cl. F16D 65/54; F16D 55/226; F16D 65/00; B60T 1/06

(52) U.S. Cl. CPC F16D 65/54; F16D 55/226; F16D 65/0043; B60T 1/065

(57) ABSTRACT

A disc brake for a motor vehicle has a brake carrier, brake pads, a brake caliper mounted on the brake carrier in an axially movable manner, a clamping device having a pressure piece with an internal thread, and an adjusting unit having an adjusting spindle (22) for adjusting a clearance of the disc brake. The adjusting spindle (22) has an external thread (28) and is screwed into the internal thread of the pressure piece and is adjusted axially via rotary movement by a resetting tool. A cylindrical adapter (32.1) is inserted into a recess (30) of the adjusting spindle (22) at an end of the adjusting spindle (22) facing away from the brake pads. The adapter (32.1) has a cavity (34) in its center designed as a tool interface for the resetting tool.

### FIELD

The present disclosure relates to a disc brake having a brake carrier, a brake caliper, and an adjusting unit, such as those used, for example, in motor vehicles, in particular in commercial vehicles.

### BACKGROUND

Disc brakes in commercial vehicles have brake pads with a friction device which, depending on the actuation of a brake encoder, are pressed by a clamping device onto a brake disc connected to a wheel to be braked in order to be able to transmit a braking effect to the brake disc and the wheel.

In the case of disc brakes, the brake pads and the brake disc wear as a result of braking. For this reason, air disc brakes used in commercial vehicles in particular have an adjusting unit with an adjusting spindle, which has the task of keeping a clearance, i.e. a distance between the brake pads and the brake disc, as constant as possible by adjusting the adjusting spindle as required.

When the usable friction device of the brake pads is finally worn, the adjusting spindle must be brought into its initial starting position or readjusted by way of a resetting unit for an upcoming brake pad change. Basically, this procedure is the same for every manufacturer and differs only in the resetting unit used, as it is manufacturer-specific or brake-specific.

However, the resetting of the spindle must not be carried out arbitrarily far and must take place within specified limits, because otherwise the function of the air disc brake can be significantly impaired; for example, by resetting the adjusting spindle, defined positions of internal components of the air disc brake can be lost. Manufacturers often refer to precise instructions and sequences in their maintenance instructions, in which the topic of the professional and damage-free resetting process of the adjusting spindle when changing the brake pad is listed.

DE 10 2014 111 229 A1 discloses a disc brake for a commercial vehicle with a brake caliper, a brake carrier on which the brake caliper is axially displaceably supported, a clamping side brake pad and a reaction side brake pad, a clamping device by way of which the brake pads can be pressed against a brake disc and which has an adjustable adjusting spindle for compensating for a wear-related change of a clearance and which is adjustable relative to the brake caliper towards the brake pad. A stop element is arranged on the brake caliper or a part connected to it, with which the displacement of at least the brake pad on the clamping side towards the brake disc is limited. This prevents wear of the brake pads beyond a permissible level of wear.

WO 2021/032262 discloses a disc brake for a motor vehicle which has a pressure piece arranged along an axial axis of the disc brake, an adjusting spindle with a thread and an adjusting unit for adjusting the clearance of the disc brake, wherein the adjusting spindle is guided axially at least partly through an opening of the pressure piece with a threaded unit, and wherein the adjusting spindle has a stop in the thread. This prevents the adjusting spindle from being rotated too far axially towards the brake disc.

### SUMMARY

It is an object of the present disclosure to specify a disc brake with a brake carrier, a brake caliper and a low-cost adjusting unit, wherein the brake caliper has a tool interface for a resetting tool, as well as a motor vehicle with a disc brake corresponding thereto.

This object is achieved by a disc brake according to the present disclosure.

The disclosure further includes advantageous developments and improvements of the present disclosure according to the following description of these measures.

The present disclosure relates to a disc brake for a motor vehicle having a brake carrier, two brake pads, a brake caliper axially displaceably mounted on the brake carrier, a clamping device having a pressure piece with an internal thread by way of which the brake pads can be pressed against a brake disc, and an adjusting unit containing an adjusting spindle for adjusting a clearance of the disc brake. The adjusting spindle has an external thread with which it is screwed into the internal thread of the pressure piece, and the adjusting spindle can be adjusted axially by way of a resetting tool by way of a rotary movement, for example for a brake pad change. The disc brake also includes a cylindrical adapter inserted into a recess of the adjusting spindle at an end of the adjusting spindle facing away from the brake pads, wherein the adapter has a cavity in its center designed as a tool interface for the resetting tool.

In a preferred embodiment, the recess of the adjusting spindle is designed as an axially extending cylindrical opening in the adjusting spindle, and the cavity of the adapter is designed as a continuous axial hole.

In an advantageous exemplary embodiment, the adapter has a conical recess on a side facing away from the adjusting spindle, in the center of which the cavity is arranged, for guiding the resetting tool towards the cavity when the resetting tool is inserted into an opening of the brake caliper.

In another advantageous exemplary embodiment, the adapter is fixed in the recess of the adjusting spindle by way of a non-positive connection, for example by way of a pressing process, and/or by way of an adhesive connection.

In another advantageous exemplary embodiment, the adapter has a cylindrical extension with which the adapter is inserted into the recess of the adjusting spindle with the extension leading.

In another advantageous exemplary embodiment, an outer circumference of the extension has a contour, for example rectangular elevations, and the recess of the adjusting spindle is designed with a corresponding contour for a positive connection between the adapter and the adjusting spindle.

In another preferred embodiment, the disc brake has a stop with a rotation limitation for resetting the adjusting spindle, wherein a stop surface for the rotation limitation is arranged on the adapter side in an area of a side of the adapter facing away from the brake pads, or a stop surface of the adjusting spindle for the rotation limitation is arranged in an area of an end of the adjusting spindle facing away from the brake pads.

In an advantageous exemplary embodiment, the adapter for the realization of the rotation limiting stop has a tooth-like contour on an outer circumference on a side facing away from the adjusting spindle, and an opening of the brake caliper has a corresponding contour on a side facing towards the adjusting spindle, by way of which the rotation limiting stop is formed. The tooth-like contour of the adapter is realized, for example, by one or more sawtooth-shaped, rectangular or trapezoidal elevations or recesses.

In another advantageous exemplary embodiment, the adapter or the adjusting spindle has a conical stop surface at an end facing away from the brake pads, and the brake caliper or a separate component of the brake caliper has an opening with a conical stop surface on a side facing towards the adjusting spindle. When the adjusting spindle is reset, the conical stop surface of the adapter or the adjusting spindle engages with the conical stop surface of the opening, so that the conical stop surfaces cause a stop with a rotation limitation.

In particular, the disc brake is designed as a sliding caliper disc brake for a commercial vehicle.

The present disclosure also relates to a motor vehicle, in particular a commercial vehicle, which is equipped with such a disc brake.

### BRIEF DESCRIPTION OF THE DRAWINGS

Exemplary embodiments of the present disclosure are shown schematically in the drawings and are explained in more detail below by way of the figures.

In the figures:

FIG. 1 shows a disc brake with a brake carrier and a brake caliper for a motor vehicle;

FIG. 2 shows an adjusting spindle and an area of the brake caliper surrounding the adjusting spindle of FIG. 1;

FIGS. 3.1-3.2 show an exemplary embodiment of an adapter attached to the adjusting spindle of FIG. 2;

FIGS. 4.1-4.2 show another exemplary embodiment of an adapter attached to the adjusting spindle of FIG. 2;

FIGS. 5.1-5.2 show an exemplary embodiment of a disc brake of FIG. 1, which has a tooth-like stop contour on an adapter attached to the adjusting spindle for the realization of a rotation limiting stop of an adjusting spindle;

FIGS. 6.1-6.4 show an exemplary embodiment of a disc brake of FIG. 1, which has a stop contour with a conical stop surface on an adjusting spindle for the realization of a rotation limiting stop; and

FIGS. 7.1-7.2 show an exemplary embodiment of a disc brake of FIG. 1, which has a stop contour with a conical stop surface on an adapter attached to the adjusting spindle for the realization of a rotation limiting stop.

### DETAILED DESCRIPTION

The present description illustrates the principles of the disclosure according to the present disclosure.

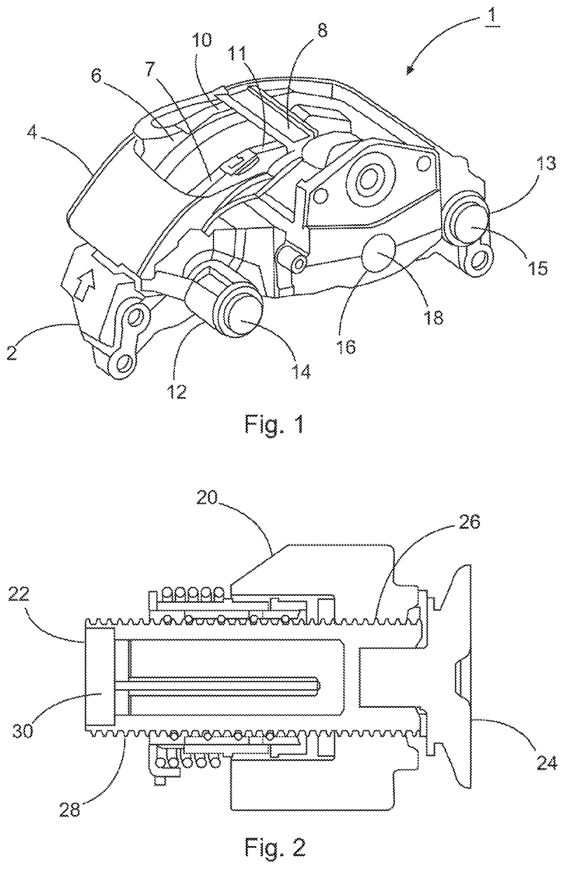

In FIG. 1 a disc brake 1 for a motor vehicle is illustrated in a lateral top view. The disc brake 1 has a brake carrier 2 and a brake caliper 4, wherein the brake caliper 4 at least partly contains a brake disc, which is not shown in FIG. 1. In the brake carrier 2, a first, reaction-side brake pad 6 and a second, clamping-side brake pad 7 are arranged, which are axially movably guided in the brake carrier 2. A hold-down bar 8 is arranged on the brake caliper 4, which exerts a force on the brake pad 6 via a hold-down spring 10 and exerts a force on the brake pad 7 via a hold-down spring 11.

The brake caliper 4 is movably arranged relative to the brake carrier 2 and slides axially on guide pins arranged in guides 12, 13 of the brake carrier 2. The guides 12, 13 are sealed by protective caps 14, 15. In this exemplary embodiment, the disc brake 1 is designed as a sliding caliper disc brake.

In the brake caliper 4, a clamping device is arranged in the center, which has a pressure piece 20 and an adjusting spindle 22, FIG. 2. When the disc brake 1 is actuated, the brake pad 7 is pressed against the brake disc by the clamping device and as a result the opposite, reaction-side brake pad 6 is pressed against the brake disc. by way of the adjusting spindle 22, a clearance for the brake pads 6, 7, a distance between the brake disc and the brake pads 6, 7, can be adjusted. If the brake pads 6, 7 have to be replaced because they are worn, the adjusting spindle 22 must be turned back with the help of a resetting tool. The adjusting spindle 22 for the resetting tool can be reached through an opening 16 in the brake caliper 4, which is sealed here by a protective cap 18. The opening 16 is sufficiently large so that the resetting tool can be inserted through the opening 16 into the brake caliper 4 for a resetting operation of the adjusting spindle 22.

In FIG. 2, the adjusting spindle 22 is schematically shown in a cross-section together with an area of the brake caliper 1 shown in FIG. 1 surrounding the adjusting spindle 22. In particular, the clamping device contains the pressure piece 20, the adjusting spindle 22 and a pressure plate 24. The pressure plate 24 is attached to the side of the adjusting spindle 22 facing the brake pads 6, 7. The adjusting spindle 22 has an external thread 28 and has a recess 30 at an end of the adjusting spindle 22 facing away from the brake pads. The pressure piece 20 has an opening with an internal thread 26 arranged axially relative to the brake disc, into which the adjusting spindle 22 is screwed, so that the pressure plate 24 can be displaced axially towards the brake pads 6, 7 by rotating the adjusting spindle 22. As a result, the clearance of the brake pads 6, 7 of the disc brake 1 can be adjusted. Adjusting spindles of this type are also known as readjusting spindles.

As a result of a braking process, the brake pads 6, 7 are worn, which means that the clearance increases with increasing wear of the brake pads. With an increasingly larger clearance, this increases a lever travel for clamping the disc brake 1, whereby braking starts with a delay, so that a vehicle with the disc brake 1 is braked with a delay due to the greater clearance.

If the usable brake pad material of the brake pads 6, 7 is worn out, the adjusting spindle 22 must be brought into its original starting position by way of a resetting tool for an upcoming brake pad change. In this case, the resetting tool is inserted through the opening 16 into the brake caliper 4 and then the adjusting spindle 22 is manually unscrewed axially away from the brake disc by a person by way of a rotational movement.

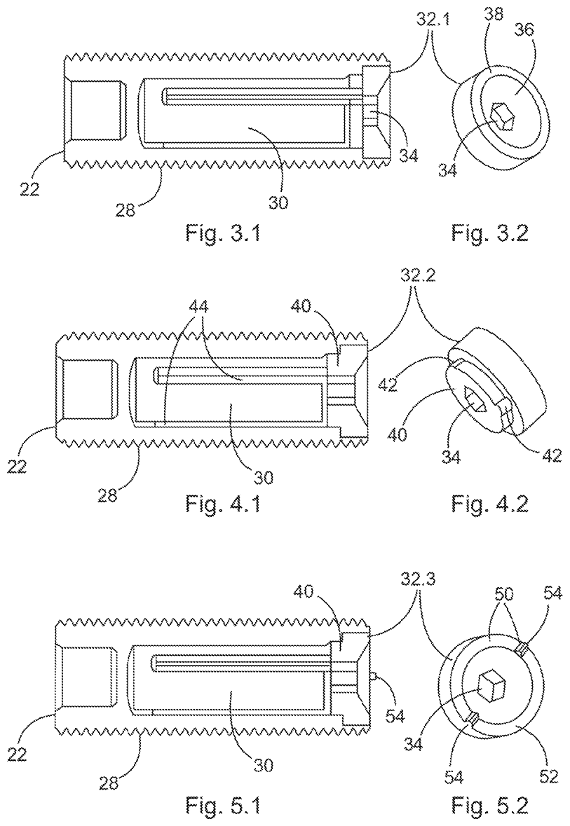

The adjusting spindle 22 is shown in FIG. 3.1 in a sectional view. In this exemplary embodiment, the recess 30 of the adjusting spindle 22 is designed as an axially extending cylindrical opening 30 into which an adapter 32.1 is inserted. The adapter 32.1 is completely seated, as shown in FIG. 3.1, or at least partially seated in the recess 30 of the adjusting spindle 22.

The adapter 32.1 is a cylindrical component that has a cavity 34 in its center, which is designed as a tool interface for a resetting tool. In a preferred exemplary embodiment, the cavity 34 is designed as an axially extending continuous hole with a hexagonal structure, as a hexagon socket. The adapter 32.1, for example, is made of metal and can be manufactured by known manufacturing processes, such as cold forming or sintering, etc.

The adapter 32.1 sits with a non-positive connection in the recess 30 of the adjusting spindle 22, for example with a press fit, caused by a pressing process. Alternatively, the adapter 32.1 may be fixed to the adjusting spindle 22 using an adhesive or may be glued to the adjusting spindle 22 in addition to a press fit so that the adapter 32.1 is permanently attached to the adjusting spindle 22.

When designing the frictional connection, it should be noted that a specific torque is introduced into the tool interface, which must be transmitted from the adapter 32.1 to the adjusting spindle 22. The tool interface can be designed accordingly for company-specific customer requirements. The disc brake 1 can therefore be adapted to a wide range of customer requirements by a suitable design of the adapter 32.1.

The adapter 32.1 is shown in FIG. 3.2 in a lateral top view. The adapter 32.1 advantageously has a conical recess 36 on a side 38 facing away from the adjusting spindle 22, in the center of which the cavity 34 is arranged, so that when the resetting tool is inserted, the resetting tool is guided into the tool interface of the adapter 32.1.

In another exemplary embodiment, an adapter 32.2 has a cylindrical, coaxial extension 40, wherein the adapter 32.2 is inserted into the recess 30 of the adjusting spindle with the cylindrical extension 40 leading, see FIGS. 4.1, 4.2. A contour, for example with elevations 42, on an outer circumference of the extension 40 is designed for a positive fit with the adjusting spindle 22. The recess 30 of the adjusting spindle 22 has a corresponding contour with corresponding notches 44, which is matched to the contour of the extension 40. This provides an optimal positive fit between the adjusting spindle 22 and the adapter 32.2 for maximum torque transmission from the resetting tool to the adjusting spindle 22. The elevations 42 can also cause jamming between the adjusting spindle 22 and the adapter 32.2.

The use of the adapter 32.1 or 32.2 in the disc brake 1 has the advantage that no design changes have to be made to the adjusting spindle 22. There is no need for a costly resetting unit, as is often used at present, as the resetting tool can be inserted directly into the tool interface of the adapter 32.1 or 32.2. The adapters 32.1, 32.2 also offer a high degree of flexibility, as they can be adapted to any shape of the adjusting spindle 22. Only simple assembly steps are necessary for the production and insertion of such an adapter into the adjusting spindle 22 during the manufacture of the disc brake 1.

In another exemplary embodiment, an adapter 32.3 has a tooth-like contour 50 on a side 52 facing away from the adjusting spindle 22, as shown in FIGS. 5.1 and 5.2. The opening 16 of the brake caliper 4, FIG. 1, has a corresponding tooth-like contour by way of which the opening 16 forms a rotation limiting stop for the adjusting spindle 22.

In a preferred exemplary embodiment, the adapter 32.3 has rectangular elevations 54 on an outer circumference of the side 52, by way of which the tooth-like contour 50 is realized. The opening 16 has a tooth-like contour on the side facing the adapter 32.3 with recesses corresponding to the tooth-like contour 50 of the adapter 32.3 and which come into contact with the tooth-like contour 50 when the adapter 32.3 is turned back to the rotation limiting stop of the opening 16. Here the elevations 54 of the adapter 32.3 latch into the recesses of the opening 16, so that this prevents further rotation of the adjusting spindle 22. Instead of the rectangular elevations 54, the contours of the adapter 32.3 and the opening 16 may also have, for example, trapezoidal elevations or recesses, rounded rectangular elevations, or other shapes.

It should be noted at this point that a simple axial stop, with which an adapter merely runs axially onto a limitation, prevents further axial displacement of an adjusting spindle connected to this adapter, but does not prevent further rotation of the adjusting spindle and consequently does not provide a protective function for a disc brake. This is the case, for example, when the adjusting spindle runs into a contour of the brake caliper. In such a condition, further rotation of the adjusting spindle is equivalent to the principle of a screw drive. In a screw drive, the rotational movement of a screw is converted into a linear movement of the nut. The principle of the screw drive then has the consequence that a pressure piece, which then corresponds to the thread of a nut, is displaced towards the brake disc. As a result of the displacement of the pressure piece, in turn, the clearance between several components of the disc brake, such as the pressure piece, a needle bearing, a lever and a sliding block of the disc brake, increases in an uncontrolled and unnoticed manner. If the clearance between these components becomes too great, these components will eventually become out of position, resulting in a loss of function of the disc brake.

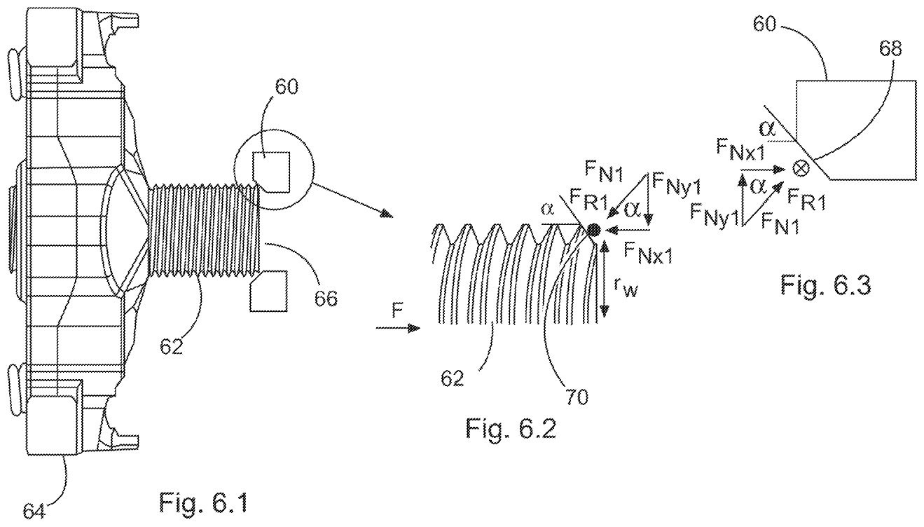

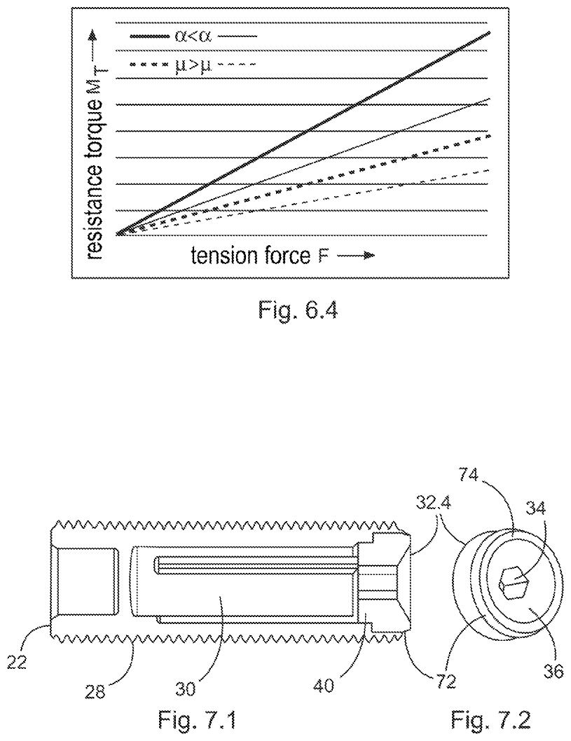

In a further exemplary embodiment, a conical stop for an end position of an adjusting spindle 62 is provided on a brake caliper 60 for limiting a rotational movement of the adjusting spindle 62 in the resetting direction, as explained below on the basis of FIGS. 6.1-6.4.

FIG. 6.1 schematically shows a pressure piece 64 with an opening having an internal thread into which the adjusting spindle 62 is screwed. The adjusting spindle 62 can be turned back in the resetting direction until it reaches a conical stop surface 68, FIG. 6.3, of the brake caliper 60. The brake caliper 60 has an opening 66 and is only indicated schematically in FIG. 6.1. The adjusting spindle 62 has a conical stop surface 70 corresponding to the conical stop surface 68 of the brake caliper 60, as shown enlarged in FIG. 6.2. If the conical stop surface 70 of the adjusting spindle 62 reaches the conical stop surface 68 of the brake caliper 60 when the adjusting spindle 62 is reset, the two stop surfaces 68 and 70 interact and a frictional force F_{R} occurs, as explained below in FIGS. 6.2 and 6.3.

The approach for the conical stop is based on the physical operating principle of an inclined plane. If the adjusting spindle 62 reaches the defined end position during a resetting operation, contact occurs between the conical stop surface 70 of the adjusting spindle 62 and the conical stop surface 68 of the brake caliper 60. A further rotation of the adjusting spindle 62 finally causes a state of tension between the adjusting spindle 62 and the brake caliper 60. Due to the conical design of the two contact surfaces, the sum of a resulting normal force F_{N} acting perpendicularly to the contact surface is greater than a tension force F. An opening angle α of the contact surfaces 68, 70 is decisive for the amplification of the resulting normal force F_{N}. As a consequence of the state of tension, the rotational motion of the adjusting spindle 62 is now counteracted by the frictional force F_{R} resulting from the normal force F_{N} and a coefficient of friction u of the contact surfaces. Taking into account an effective radius r_{w}, a resistance torque M_{T} is obtained, which in turn counteracts further torsion on the adjusting spindle 62 and continuously increases the torsional resistance with increasing torsion. The frictional force F_{R} can be calculated according to F_{R}=μ·F_{N} with F_{N}=F/sin α.

The resistance torque M_{T} can then be calculated from the tension force F, friction force F_{R}, coefficient of friction μ and the effective radius r_{w} using the following formula:

M_{T}=r_{w}·F_{R}=r_{w}·μ·F_{N}=r_{w}·μ·F/sin α

In FIG. 6.4 the relationship between the resistance torque M_{T} and the tension force F for different opening angles α and coefficients of friction u is shown in a diagram. As a result, when designing the conical stop surfaces 68, 70, a small opening angle α, for example α<15°, as well as the largest possible coefficient of friction u, for example μ>0.15, is to be preferred.

The advantage of this approach is that the conical stop 68 can be realized directly on the brake caliper 60, both by adapting the blank and/or adapting the machining concept, and also by using a separate component attached to the brake caliper 60. The separate component has an opening into which a resetting tool can be inserted for a resetting operation on the adjusting spindle 62. When using the separate component, another advantage is increased flexibility in the structural design of the stop surface of the separate component.

A further exemplary embodiment of a disc brake 1 with a rotation limiting stop in the resetting direction of the adjusting spindle 22 is shown in FIGS. 7.1 and 7.2. Here, a conical stop is used to limit the rotational motion of the adjusting spindle 22, as explained above on the basis of FIGS. 6.1-6.3. The disc brake 1 has an adapter 32.4, which is only partially inserted into the adjusting spindle 22 and protrudes with one end from the recess 30 of the adjusting spindle 22. The adapter 32.4 has a conical stop surface 72 on its outer circumference on a side facing away from the adjusting spindle 22. A brake caliper, for example the brake caliper 60, FIG. 6.1, contains a conical stop surface that corresponds to the conical stop surface 72 for realizing a rotation limiting stop for the adjusting spindle 22.

If the adjusting spindle 22 is turned back by way of a resetting tool, this prevents further rotation of the adjusting spindle 22 when the conical stop surface 72 of the adapter 32.4 reaches the conical stop surface of the brake caliper 60. The geometry of the conical stop surface of the brake caliper 60 and the conical stop surface 72 of the adjusting spindle 22 and the material properties of the adapter 32.4 and the opening of the brake caliper 60 are selected here in such a way that a stop with a rotation limitation is created, as explained above on the basis of FIGS. 6.1-6.4.

All examples mentioned herein, as well as conditional formulations, are to be understood without limitation to such specifically cited exemplary embodiments. The disclosure is not limited to the exemplary embodiments described herein. There is room for various adjustments and modifications that the person skilled in the art would consider as also belonging to the disclosure on the basis of his expertise.

### LIST OF REFERENCE SIGNS (PART OF THE DESCRIPTION)

1 disc brake
2 brake carrier
3 brake caliper
6, 7 brake pads
8 hold-down bar
10, 11 hold-down springs
12, 13 guides of the brake carrier
14, 15 protective caps of the guides
16 opening of the brake caliper 4
18 protective cap of the opening 16
20 pressure piece
22 adjusting spindle
24 pressure plate
26 internal thread of the pressure piece
28 external thread of the adjusting spindle
30 recess of the adjusting spindle
32.1-32.4 adapters
34 cavity of the adapter
36 conical recess of the adapter 32.1
38 side of the adapter 32.1
40 cylindrical extension
42 elevations of the cylindrical extension
44 notches
50 tooth-like contour of the adapter 32.3
52 side of the adapter 32.3
54 elevations of the adapter 32.3
60 brake caliper
62 adjusting spindle
64 pressure piece
66 opening of the brake caliper 60
68 conical stop surface of the brake caliper 60
70 conical stop surface of the adjusting spindle 62
72 conical stop surface of the adapter 32.4
74 side of the adapter 32.4
α opening angle
μ coefficient of friction

1. A disc brake (1) for a motor vehicle, the disc brake comprising:
a brake carrier (2),
two brake pads (6,7),
a brake caliper (4, 60) axially adjustably supported on the brake carrier,
a clamping device having a pressure piece (20) with an internal thread (26) by which the brake pads can be pressed against a brake disc, and
an adjusting unit having an adjusting spindle (22, 62) for setting a clearance of the disc brake,
wherein the adjusting spindle has an external thread (28) that is screwed into the internal thread of the pressure piece, and
wherein the adjusting spindle can be axially reset via rotational movement by a resetting tool,
wherein a cylindrical adapter (32.1-32.4) is disposed in a recess (30) of the adjusting spindle (22, 62) at an end of the adjusting spindle (22, 62) facing away from the brake pads,
wherein the adapter (32.1-32.4) has a cavity (34) in its center designed as a tool interface for the resetting tool.

2. The disc brake (1) as claimed in claim 1, wherein the recess (30) of the adjusting spindle (22, 62) is an axially extending cylindrical opening in the adjusting spindle (22, 62), and the cavity (34) of the adapter (32.1-32.4) is a continuous axially extending hole.

3. The disc brake (1) as claimed in claim 1, wherein the adapter (32.1-32.4) has a conical recess (36) on a side facing away from the adjusting spindle (22, 62), wherein the cavity (34) is arranged in the center of the conical recess, wherein the concical recess guides the resetting tool to the cavity (34) when the resetting tool is inserted into an opening (16, 66) of the brake caliper (4, 60).

4. The disc brake (1) as claimed in claim 1, wherein the adapter (32.1-32.4) is fixed in the recess (30) of the adjusting spindle (22, 62) by a non-positive connection.

5. The disc brake (1) as claimed in claim 1, wherein the adapter (32.2-32.4) has a cylindrical extension (40), wherein the adapter (32.2-32.4) is inserted into the recess (30) of the adjusting spindle (22, 62) with the extension (40) leading.

6. The disc brake (1) as claimed in claim 5, wherein a contour including elevations (42) is formed on an outer circumference of the extension (40) and the recess (30) of the adjusting spindle (22, 62) has a corresponding contour (44) that provides a positive connection between the adapter (32.2-32.4) and the adjusting spindle (22, 62).

7. The disc brake (1) as claimed in claim 1, wherein the disc brake has a stop having a rotation limitation for resetting the adjusting spindle (22, 62), and wherein a stop surface (50, 70, 72) for the rotation limitation is arranged on a side (52, 74) of the adapter (32.3, 32.4) facing away from the brake pads, or a stop surface (70) of the adjusting spindle (62) for the rotation limitation is arranged on an end of the adjusting spindle (62) facing away from the brake pads.

8. The disc brake (1) as claimed in claim 7, wherein the adapter (32.3) has a tooth-like contour (50) on a side (52) facing away from the adjusting spindle (22) configured to engage a corresponding contour on a side of the brake caliper facing towards the adjusting spindle (22) for limiting rotation.

9. The disc brake (1) as claimed in claim 8, wherein the tooth-like contour (50) of the adapter (32.3) has one or more sawtooth-shaped, rectangular, or trapezoidal elevations (54) or recesses.

10. The disc brake (1) as claimed in claim 7, wherein the adapter (32.4) or the adjusting spindle (62) has a conical stop surface (72, 70) at the end of the adjusting spindle facing away from the brake pads,
the brake caliper (60) or a separate component of the brake caliper has an opening (66) with a conical stop surface (68) on a side facing towards the adjusting spindle (22, 62), and
the conical stop surface (72, 70) of the adapter (32.4) or of the adjusting spindle (62) engages the conical stop surface (68) of the opening (66) when the adjusting spindle (22, 62) is reset, and the engaged conical stop surfaces (68, 72, 70) thereby cause a stop with a rotation limit.

11. The disc brake (1) as claimed in claim 1, wherein the disc brake is a sliding caliper disc brake operated with compressed air for a commercial vehicle.

12. A motor vehicle comprising the disc brake (1) as claimed in claim 1.

13. The disc brake (1) as claimed in claim 1, wherein the adapter is a separate piece relative to the adjusting spindle, whereby the adapter can be removed and replaced to provide for various tool-adapter interface.

14. The disc brake (1) as claimed in claim 10, wherein the conical stop surfaces limit rotation in response to increased friction.

15. The disc brake (1) as claimed in claim 10, wherein the adapter includes the conical stop surface, wherein the adapter is partially received in the recess of the adjusting spindle, and the conical stop surface of the adapter projects beyond the end of the adjusting spindle.

16. The disc brake (1) as claimed in claim 1, wherein the adapter is fully received in the recess of the adjusting spindle.

17. The disc brake (1) as claimed in claim 8, wherein the tooth-like contour projects beyond the end of the adjusting spindle.

18. The disc brake (1) as claimed in claim 7, wherein the rotation limitation correspondingly limits axial movement of the pressure piece.
